(19) United States
(12) Patent Application Publication
(10) Pub. No.: US 2024/0198301 A1
(43) Pub. Date: Jun. 20, 2024

(54) EDUCTORS HAVING HYDROPHOBIC SURFACES AND METHODS OF REDUCING DEPOSITION OF A FRICTION REDUCER ON A SURFACE

(71) Applicant: ACULON, INC., SAN DIEGO, CA (US)

(72) Inventors: Eric L. Hanson, Carlsbad, CA (US); Eric L. Bruner, La Jolla, CA (US); Majid Monji, San Diego, CA (US); Elizabeth Cambre, Texas City, TX (US); Edward Hughes, San Diego, CA (US)

(21) Appl. No.: 18/538,190

(22) Filed: Dec. 13, 2023

Related U.S. Application Data
(60) Provisional application No. 63/432,215, filed on Dec. 13, 2022.

(51) Int. Cl. B01F 25/312; C08G 65/22; C08J 7/04; C09D 171/00; C09K 8/80

(52) U.S. Cl. CPC B01F 25/31243; C08G 65/226; C08J 7/042; C09D 171/00; C09K 8/80

(57) ABSTRACT

The present invention provides eductors comprising: a component having a metal surface: and a hydrophobic surface layer applied thereto, directly or through an intermediate layer. The surface layer comprises a self-assembled monolayer prepared from a fluorinated material having the structure:

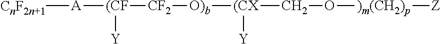

wherein A is an oxygen radical or a chemical bond; n is 1 to 20; Y is H, F, CₙH₂ₙ₊₁ or CₙF₂ₙ₊₁; X is H or F; b is at least 1, m is 0 to 50, p is 1 to 20, and Z is an acid group or an acid derivative. Also provided is a method of reducing deposition of a friction reducer on a metal surface of a component of an eductor, comprising: contacting the surface with a fluorinated material in a diluent, wherein the fluorinated material has the structure above; forming a film on the metal surface; and introducing the friction reducer into the apparatus.

### CROSS REFERENCE TO RELATED APPLICATION

The present application claims priority to U.S. Provisional Patent Application Ser. No. 63/432,215, filed Dec. 13, 2022, titled “Surface-Treated, Transportable ISO Tanks and Deposition Reduction of a Friction Reducer; Eductors having Hydrophobic Surfaces and Deposition Reduction of a Friction Reducer; Surface-Treated Gravel Pack Screens and Deposition Reduction of a Contaminant Thereon; Methods of Reducing Friction on an Apparatus that Stores or Transports a Gas; and Methods of Reducing Deposition of a Contaminant on a Metal Cutting Blade”, which application is incorporated herein by reference in its entirety.

### FIELD OF THE INVENTION

The present invention relates to eductors having hydrophobic surfaces and methods of reducing deposition of a friction reducer on a metal surface of a component of an eductor.

### BACKGROUND OF THE INVENTION

Hydraulic fracturing fluid, also known as fracking fluid, is primarily water mixed with sand, also called proppant. The fluid usually further contains several additives that improve the fluid's performance. The proppant keeps small fissures created by the hydraulic fracturing operation from collapsing when an oil well moves into the production phase. Pumping the fluid down the wellbore creates friction between the fracking fluid and the well's piping. This increased friction causes wear on pumps and other drilling equipment over time.

Friction reducers are often used as additives to minimize the friction in the wellbore. The large volumes of water pumped during such operations, and high flow rates required, result in high friction pressures from turbulent fluid flow. Friction reducers increase the fluid viscosity, reduce turbulence, prevent friction losses, and reduce wear on equipment. The reduced friction also increases pump efficiency, and increased viscosity helps keep proppant in suspension and evenly distributed throughout the fluid.

Friction reducers are polyacrylamide polymers. They are often supplied as dry, fine or ultra-fine powders when delivered to a drilling site. Dry friction reducer units are used to hydrate the dry polymer in the field for fracturing operations.

An eductor is a device that works on the venturi effect for pump operation. It is a type of jet pump used to pump out liquid/sediments often where the suction head is too low for the normal pump to operate. A primary fluid medium is used to create a vacuum, based on the venturi effect and Bernoulli principle, to draw in the secondary air, gas or liquid.

Eductors and other peripherals to the units are often made of stainless steel components to minimize corrosion. Over time, residue of the polymer is deposited on the stainless steel surfaces of the eductor components, and can start to obstruct the entrance of the eductor. A slower rate of polymer addition to the eductor due to this obstruction can impact the dosing of the friction reducer that is being hydrated in the field on demand. This can have detrimental effects on the fracturing operation by slowing production and negatively impacting the properties of the fluid. It would be desirable to provide novel, surface-treated, eductors that resist deposition of a friction reducer on their component surfaces.

### SUMMARY OF THE INVENTION

The present invention is directed to eductors, each eductor comprising:
a) a component having a metal surface; and
b) a hydrophobic surface layer applied to the metal surface either directly or through an intermediate organometallic layer, said hydrophobic surface layer comprising a self-assembled monolayer prepared from a fluorinated material having the following structure:

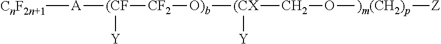

wherein A is an oxygen radical or a chemical bond; n is 1 to 20; Y is H, F, CₙH₂ₙ₊₁ or CₙF₂ₙ₊₁; X is H or F; b is at least 1, m is 0 to 50, p is 1 to 20, and Z is an acid group or an acid derivative.

The present invention is further directed to a method of reducing deposition of a friction reducer on a metal surface of a component of an eductor, the method comprising:
(a) contacting the surface either directly or through an intermediate organometallic layer with a fluorinated material in a diluent, wherein the fluorinated material has the structure above;
(b) forming a film on the metal surface; and
(c) introducing the friction reducer into the apparatus.

These and other advantages of the present invention will be clarified in the following description of the present invention taken together with the attached figures in which like reference numerals represent like elements throughout.

### BRIEF DESCRIPTION OF THE DRAWINGS

FIG. 1 is a schematic cross-sectional view of an eductor of the present invention.

FIG. 2 is a schematic cross-sectional view of a portion of an eductor of the present invention.

FIG. 3 is a schematic cross-sectional view of a portion of an eductor of the present invention that includes an intermediate organo-metallic layer.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

As used herein, “formed from” denotes open, e. g., “comprising,” claim language. As such, it is intended that a composition “formed from” a list of recited components be a composition comprising at least these recited components, and can further comprise other, non-recited components, during the composition's formation.

As used herein, the term “inorganic material” means any material that is not an organic material.

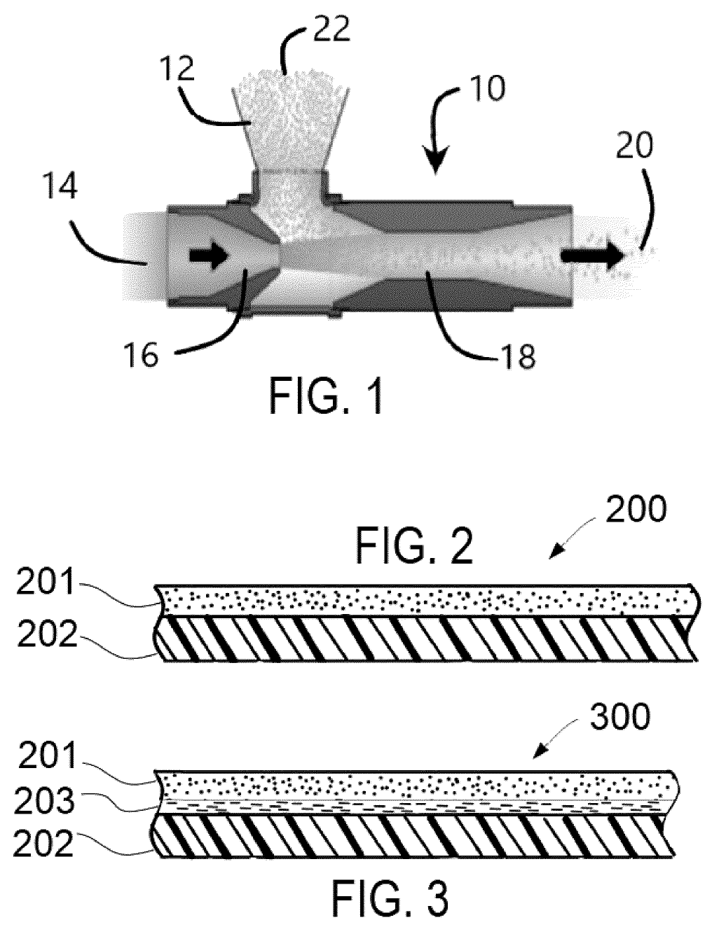

As noted above, the present invention is directed to an eductor 10 as shown, for example, in FIG. 1. The eductor comprises numerous components: a liquid inlet 14 through which water or fracking fluid enters the eductor 10, and an inlet hopper 12 through which the friction reducer 22 is introduced into the eductor 10, typically by vacuum. The eductor 10 further includes a converging inlet nozzle 16, a diffuser throat 18, and a diverging outlet 20. The components of the eductor 10 have an interior metal surface 202, shown in FIGS. 2 and 3. The metal surface 202 is typically made of steel, such as a stainless steel surface to minimize corrosion.

The components of the eductor 10 are surface-treated with a hydrophobic surface layer 201 applied to the metal surface 202. For example, the metal surface 202 may be an interior surface of the inlet hopper 12, the converging inlet nozzle 16, the diffuser throat 18, and/or the diverging outlet 20. A schematic cross-sectional view of a portion 200 of an eductor is illustrated in FIG. 2. The hydrophobic surface layer 201 comprises a self-assembled monolayer prepared from a fluorinated material in a treatment composition. The fluorinated material has the following structure:

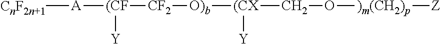

wherein A is an oxygen radical or a chemical bond; n is 1 to 20; Y is H, F, CₙH₂ₙ₊₁ or CₙF₂ₙ₊₁, X is H or F; b is at least 1, m is 0 to 50, p is 1 to 20, and Z is an acid group or an acid derivative.

In particular examples of the present invention, n is 1 to 6; b is 5 to 12, m is 1 to 6, and p is 2 to 4. Often, Z is selected from:

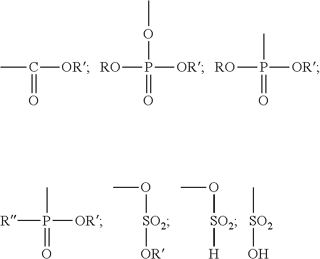

where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons. Typically, Z is

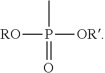

The treatment composition may further comprise a diluent to form a solution.

Suitable diluents include alcohols such as methanol, ethanol or propanol; aliphatic hydrocarbons such as hexane, isooctane and decane, ethers, for example, tetrahydrofuran and dialkylethers such as diethylether. Diluents for fluorinated materials can include perfluorinated compounds such as perfluorinated tetrahydrofuran. Also, aqueous alkaline solutions such as sodium and potassium hydroxide can be used as the diluent. In certain examples of the present invention, the diluent may comprise a slow-drying solvent such as glycols, glycol ethers, and hydrofluoroether solvents. Examples of particular hydrofluoroether solvents include 1,1,1,2,2,3,3,4,4-nonafluoro-4-methoxybutane and/or 1,1,1,2,2,3,3,4,4-nonafluoro-4-ethoxybutane, commercially available from 3M Corporation as NOVEC 7200. Other exemplary solvents include 3-ethoxyperfluoro(2-methylhexane) (HFE 7500, also available from 3M Corporation); 1H,1H,5H-Octafluoropentyl-1,1,2,2-tetrafluoroethyl ether (HFE 6512, available from Fuxin Hengtong); and/or 1,1,1,2,3,4,4,5,5,5-Decafluoropentane (VERTREL XF, available from E. I. DuPont de Nemours). Slower drying solvents provide application latitude and control, and are particularly useful when the treatment composition is to be used in regions with warmer weather, and where climate control is not available.

Adjuvant materials may be present in the treatment composition. Examples include surface active agents, stabilizers, and anti-static agents. The adjuvants if present are present in amounts of up to 30 percent by weight, based on the non-volatile content of the treatment composition.

The concentration of the fluorinated material in the solution is not particularly critical but is at least 0.01 millimolar, typically 0.01 to 100 millimolar, and more typically 0.1 to 50 millimolar. The solution can be prepared by mixing all of the components at the same time or by adding the components in several steps.

The treatment composition can be contacted with the metal surface 202 typically by immersion (which allows for coating both the interior and exterior surfaces), spraying, flow coating, brush application or the like, followed by evaporating the solution medium at ambient temperatures or by the application of heat to effect formation of the self-assembled monolayer. The treatment composition may also be applied by wiping with a cloth. Slower drying solvents in the formulation are particularly useful for wipe application to minimize waste. The treatment composition may also be allowed to flow through the eductor 10 after the eductor is in-line (“in situ”). This allows for the treatment of other line components associated with, but not integral to, the eductor, such as splicers/couplers.

Adherence of the hydrophobic surface layer 201 to the metal surface 202 as shown in FIG. 2 may be through physical attraction or through chemically bonding. With physical attraction it is believed the group Z is in the form of the acid, rather than a salt or ester. In the case of chemical bonding, it is believed the acid forms an ionic or covalent bond with reactive groups on the metal surface.

The resultant self-assembled monolayer typically is of nano dimensions, having a thickness of no greater than 100 nm, typically about 10-100 nanometers. The layer is hydrophobic, having a water contact angle greater than 70°, typically from 75-130°. The water contact angle can be determined using a contact angle goniometer such as a TANTEC contact angle meter Model CAM-MICRO.

The hydrophobic surface layer 201 may be adhered to the metal surface 202 either directly, or indirectly through an intermediate organometallic coating 203 as shown in FIG. 3. When better adhesion and durability than that afforded by direct application is desired, an organometallic coating 203 should be applied to the metal surface 202 followed by application of the treatment composition.

The organometallic compound used in the intermediate organometallic coating 203 is usually derived from a metal or metalloid, often a transition metal, selected from Group III and Groups IIIB, IVB, VB and VIB of the Periodic Table. Transition metals are used most often, such as those selected from Groups IIIB, IVB, VB and VIB of the Periodic Table. Examples are tantalum, titanium, zirconium, lanthanum, hafnium and tungsten. Niobium is also a suitable metal. The organo portion of the organometallic compound is selected from those groups that are reactive with the organophosphorus acid. Also, as will be described later, the organo group of the organometallic compound is believed to be reactive with groups on the surfaces being treated such as oxide and hydroxyl groups. Examples of suitable organo groups of the organometallic compound are alkoxide groups containing from 1 to 18, usually 2 to 4 carbon atoms, such as ethoxide, propoxide, isopropoxide, butoxide, isobutoxide, tert-butoxide and ethylhexyloxide. Mixed groups such as alkoxide, acetyl acetonate and chloride groups can be used.

The organometallic compounds can be in the form of simple alkoxylates or polymeric forms of the alkoxylate, and various chelates and complexes. For example, in the case of titanium and zirconium, the organometallic compound can include one or more of:
a) alkoxylates of titanium and zirconium having the general formula M(OR)₄, wherein M is selected from Ti and Zr and R is C₁₋₁₈ alkyl,
b) polymeric alkyl titanates and zirconates obtainable by condensation of the alkoxylates of (a), i.e., partially hydrolyzed alkoxylates of the general formula RO[-M(OR)₂O-]ₓ₋₁R, wherein M and R are as above and x is a positive integer, c) titanium chelates, derived from ortho titanic acid and polyfunctional alcohols containing one or more additional hydroxyl, halo, keto, carboxyl or amino groups capable of donating electrons to titanium. Examples of these chelates are those having the general formula:

Ti(O)ₐ(OH)_{b}(OR′)_{c}(XY)_{d}

wherein a=4-b-c-d; b=4-a-c-d; c=4-a-b-d; d=4-a-b-c; R′ is H, C₁₋₁₈ alkyl, or X-Y, wherein X is an electron donating group such as oxygen or nitrogen and Y is an aliphatic radical having a two- or three-carbon atom chain such as
I. —CH₂CH₂—, e.g, of ethanolamine, diethanolamine and triethanolamine
II.

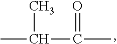

e.g., of lactic acid;
III.

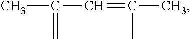

e.g., of acetylacetone endo form; or
IV.

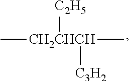

e.g., as in 1,3-octyleneglycol;
d) titanium acrylates having the general formula Ti(OCOR)₄₋ₙ(OR)ₙ wherein R is C₁₋₁₈ alkyl as above and n is an integer of from 1 to 3, and polymeric forms thereof, or
e) mixtures thereof.

The organometallic compound can be dissolved or dispersed in a diluent to form a solution. Examples of suitable diluents are alcohols such as methanol, ethanol and propanol, aliphatic hydrocarbons, such as hexane, isooctane and decane, ethers, for example, tetrahydrofuran and dialkyl ethers such as diethyl ether. The concentration of the organometallic compound in the solution is not particularly critical but is usually at least 0.01 millimolar, typically from 0.01 to 100 millimolar, and more typically from 0.1 to 50 millimolar.

Also, adjuvant materials may be present in the solution. Examples include stabilizers such as sterically hindered alcohols, surfactants and anti-static agents. The adjuvants if present are present in amounts of up to 30 percent by weight, based on the non-volatile content of the composition.

The organometallic treatment solution can be prepared by mixing all of the components at the same time or by combining the ingredients in several steps. If the organometallic compound chosen is reactive with moisture, (e.g. in the case of titanium (IV) n-butoxide, tantalum (V) ethoxide, aluminum (III) isopropoxide, etc.), care should be taken that moisture is not introduced with the diluent or adjuvant materials and that mixing is conducted in a substantially anhydrous atmosphere.

The organometallic solution can be contacted with the metal surface 202 typically by immersion, spraying, flow coating, brush application or the like, followed by removing excess solution and evaporating the diluent. This can be accomplished by heating to 50-200° C. or by simple exposure to ambient temperature, that is, from 20-25° C. Alternatively, the organometallic compound can be used neat and applied by vapor deposition techniques.

The resulting film may be in the form of a polymeric metal oxide with unreacted alkoxide and hydroxyl groups. This is accomplished by depositing the film under conditions resulting in hydrolysis and self-condensation of the alkoxide. These reactions result in a polymeric metal oxide coating being formed. The conditions necessary for these reactions to occur is to deposit the film in the presence of water, such as a moisture containing atmosphere; however, these reactions can be performed in solution by the careful addition of water. The resulting film has some unreacted alkoxide groups and/or hydroxyl groups for subsequent reaction and possible covalent bonding with the organophosphorus acid. Note that the phrase “and/or” when used in a list is meant to encompass alternative embodiments including each individual component in the list as well as any combination of components. For example, the list “A, B, and/or C” is meant to encompass seven separate embodiments that include A, or B, or C, or A+B, or A+C, or B+C, or A+B+C.

Although not intending to be bound by any theory, it is believed the polymeric metal oxide is of the structure:

[M(O)ₓ(OH)_{y}(OR)_{z}]ₙ

where M is the metal being used, R is an alkyl group containing from 1 to 30 carbon atoms; x+y+z=V, the valence of M; x is at least 1, y is at least 1, z is at least 1; x=V−y−z; y=V−x−z; z=V−x−y; n is greater than 2, such as 2 to 1000.

When the organometallic compound is used neat and applied by chemical vapor deposition techniques in the absence of moisture, a thin metal alkoxide film is believed to form. Polymerization, if any occurs, is minimized and the film may be in monolayer configuration. The resulting film typically has a thickness of 0.5 to 100 nanometers. When the organometallic compound is subjected to hydrolysis and self-condensation conditions as mentioned above, somewhat thicker films are formed.

Although not intending to be bound by any theory, it is believed the acid groups of the Z moiety chemically bond with oxide or hydroxyl groups on the metal surface or chemically bond with the hydroxyl or alkoxide group of the organometallic coating, resulting in a durable film. It is believed that the fluorinated material forms a self-assembled monolayer on the surface of the substrate (i, e., the metal surface or organometallic coating layer). Self-assembled layers or films are formed by the chemisorption and spontaneous organization of the material on the surface of the substrate. The fluorinated materials useful in the practice of the invention are amphiphilic molecules that have two functional groups. The first functional group, i.e., the head functional group, is the acid group and attaches by physical attraction or by chemical bonding to the surface of the substrate. The second functional group, the fluoro-functional group, i.e., the tail, extends outwardly from the surface of the substrate.

Typically, the hydrophobic surface layer 201 is adhered to the interior metal surfaces 202 of the components 200, 300 of the eductor 10, rendering the surfaces of the eductor components 200, 300 resistant to deposition of a friction reducer thereon.

The present invention is further directed to a method of reducing deposition of a friction reducer on a metal surface 202 of a component 200, 300 of an eductor 10. The method comprises: (a) contacting the surface as discussed earlier, either directly or through an intermediate organometallic layer 203, with a fluorinated material in a diluent. The fluorinated material may have any of the structures shown above. The method further comprises (b) forming a hydrophobic surface layer 201 on the surface 202. Typically, the fluorinated material is dissolved or dispersed in a diluent to form a solution or dispersion (i. e., the treatment composition discussed above), and the solution or dispersion is coalesced on the surface to form the hydrophobic surface layer 201. Film formation may be achieved as discussed above. After formation of the hydrophobic surface layer 201 on the metal surface 202, the method comprises c) introducing the friction reducer 22 into the eductor 10. The friction reducer typically comprises a polyacrylamide polymer as known in the art, and is typically introduced in to the eductor 10 as a dry, particulate solid 22. The hydrophobic surface layer 201 on the metal surface 202 reduces deposition of the friction reducer on the metal surface 202, decreasing the likelihood of obstructing the eductor 10.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. An eductor comprising:
a) a component having a metal surface; and
b) a hydrophobic surface layer applied to the metal surface either directly or through an intermediate organometallic layer, said hydrophobic surface layer comprising a self-assembled monolayer prepared from a fluorinated material having the following structure: [symbol]
wherein A is an oxygen radical or a chemical bond; n is 1 to 20; Y is H, F, CₙH₂ₙ₊₁ or CₙF₂ₙ₊₁; X is H or F; b is at least 1, m is 0 to 50, p is 1 to 20, and Z is an acid group or an acid derivative.

2. The eductor of claim 1, wherein the metal surface comprises stainless steel.

3. The eductor of claim 1, wherein the component comprises a splicer, an inlet hopper, a converging inlet nozzle, a diffuser throat, or a diverging outlet.

4. The eductor of claim 1 wherein Z is selected from:
where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons.

5. The eductor of claim 4 wherein Z is

[symbol]

6. The eductor of claim 1 wherein n is 1 to 6; b is 5 to 12, m is 1 to 6, and p is 2 to 4.

7. The eductor of claim 1 wherein the fluorinated material is adhered to an intermediate organometallic layer.

8. The eductor of claim 7 wherein the intermediate organometallic layer is a polymeric metal oxide with alkoxide and hydroxyl groups.

9. A method of reducing deposition of a friction reducer on a metal surface of a component of an eductor, the method comprising:
(a) contacting the surface either directly or through an intermediate organometallic layer with a fluorinated material in a diluent, wherein the fluorinated material has the following structure: [symbol]
wherein A is an oxygen radical or a chemical bond; n is 1 to 20; Y is H, F, CₙH₂ₙ₊₁ or CₙF₂ₙ₊₁; X is H or F; b is at least 1, m is 0 to 50, p is 1 to 20, and Z is an acid group or an acid derivative; (b) forming a hydrophobic surface layer on the surface; and (c) introducing the friction reducer into the eductor.

10. The method of claim 9 wherein the friction reducer comprises a polyacrylamide polymer.

11. The method of claim 9 wherein the component comprises an inlet hopper, a converging inlet nozzle, a diffuser throat, or a diverging outlet.

12. The method of claim 9 wherein the surface comprises stainless steel.

13. The method of claim 9 wherein the fluorinated material is dissolved or dispersed in a diluent to form a solution or dispersion, and the solution or dispersion is coalesced on the surface to form the hydrophobic surface layer.

14. The method of claim 9 wherein Z is selected from: [symbol]
where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons.

15. The method of claim 14 wherein Z is

[symbol]

16. The method of claim 9 wherein n is 1 to 6; b is 5 to 12, m is 1 to 6, and p is 2 to 4.

17. The method of claim 9 wherein the fluorinated material in the hydrophobic surface layer is adhered to an intermediate organometallic layer.

18. The method of claim 17 wherein the intermediate organometallic layer is a polymeric metal oxide with alkoxide and hydroxyl groups.

19. The method of claim 9, wherein the diluent comprises at least one of a glycol, a glycol ether, 1,1,1,2,2,3,3,4,4-nonafluoro-4-methoxybutane, 1,1,1,2,2,3,3,4,4-nonafluoro-4-ethoxybutane, 3-ethoxyperfluoro(2-methylhexane), 1H,1H,5H-Octafluoropentyl-1,1,2,2-tetrafluoroethyl ether, and 1,1,1,2,3,4,4,5,5,5-Decafluoropentane.

20. The method of claim 19 wherein Z is selected from: [symbol]
where R″ is a hydrocarbon or substituted hydrocarbon radical having up to 200 carbons, and R and R′ are each independently H, a metal or an amine or an aliphatic or substituted aliphatic radical having 1 to 50 carbons or an aryl or substituted aryl radical having 6 to 50 carbons.
